(19) United States
(12) Patent Application Publication
(10) Pub. No.: US 2018/0106668 A1
(43) Pub. Date: Apr. 19, 2018

(54) BIJECTION PHOTOELECTRIC SENSOR AND TARGET DETECTION SYSTEM

(71) Applicant: OMRON Corporation, Kyoto (JP)

(72) Inventors: Motoharu OKUNO, Shanghai (CN); Guopei LI, Shanghai (CN); Xue YANG, Shanghai (CN); Ji SHI, Shanghai (CN); Ming ZHU, Shanghai (CN)

(73) Assignee: OMRON Corporation, Kyoto (JP)

(21) Appl. No.: 15/705,285

(22) Filed: Sep. 15, 2017

(30) Foreign Application Priority Data
Oct. 19, 2016 (CN) 201610911237.4

(51) Int. Cl. G01J 1/04; G01J 1/44; G01J 1/42

(52) U.S. Cl. CPC G01J 1/0411; G01J 1/4228; G01J 1/44

(57) ABSTRACT

Embodiments of the invention relate to a bijection photoelectric sensor and a target detection system. The bijection photoelectric sensor includes a light projector and a light receiver. The light projector includes: a light emitting device, emitting light; a first lens, converting the light emitted by the light emitting device into parallel light; and a first baffle, located between the light emitting device and the first lens. A first through hole is provided on the first baffle. A center of the first through hole is overlapped with a focal point of the first lens. In addition, a visual field formed by the light emitted by the light emitting device is controlled through the first through hole. According to the embodiments of the invention, a light spot with a sufficient amount of light and in a desired shape is able to be obtained.

### CROSS-REFERENCE TO RELATED APPLICATION

This application claims the priority benefit of China patent application no. 201610911237.4, filed on Oct. 19, 2016. The entirety of the above-mentioned patent application is hereby incorporated by reference herein and made a part of this specification.

### BACKGROUND OF THE INVENTION

### 1. Field of the Invention

The invention relates to a photoelectric sensor, and particularly relates to a bijection photoelectric sensor and a target detection system using the same.

### 2. Description of Related Art

In the conventional techniques, a focal point of a lens in a light projector of a bijection photoelectric sensor is normally set at a light source, such as an LED chip, as shown in FIG. 1. However, since a wire bonding (W/B) part on a die of the LED chip does not emit light, the amount of light at a central part of a light spot projected to a light receiver is insufficient, and a W/B shadow effect is thus rendered, as shown in FIG. 2. As a result, an error is likely to occur when the bijection photoelectric sensor is adopted to detect whether a target is present.

To reduce such error, the LED chip may be moved toward the lens in the light projector to be arranged in a defocus state, as shown in FIG. 3. Accordingly, the influence of the W/B shadow is eliminated, as shown in FIG. 4. However, currently, a required distance of the movement of the LED chip can only be determined through optical simulation. In other words, the amount of the movement of the LED chip toward the lens cannot be set based on theory in the design, but can only be obtained through practical validation.

Regarding the bijection photoelectric sensor mounted in a subway baffle gate to detect people passing, in order to reduce the space occupied, it is the trend of the industry to make the baffle gate thinner. Meanwhile, in order to increase the reliability of target detection, the number of bijection photoelectric sensors mounted needs to be increased. However, a spacing distance between the adjacent bijection photoelectric sensors that are mounted is consequently reduced. In order to prevent the adjacent bijection photoelectric sensors from interfering with each other, it is required that the bijection photoelectric sensor has a smaller light projecting/receiving visual field.

However, currently, the mounting space in the thinner baffle gate is normally too small to mount a mounting rack adjusting an angle of the light receiver. Besides, if the design simply reduces the visual field, it becomes challenging to align optical axes of the light projector and the light receiver when the light projector and the light receiver are being mounted.

Moreover, during mounting of the light projector and the light receiver, the optical axis of the light receiver needs to be aligned with the optical axis of the light projector. However, due to influences of offsets of components in the LED and/or offsets arising from assembling of a printed wire board (PWB), the optical axes may be offset, and the center of the light spot may thus be moved relative to the mechanical axis. As a consequence, the light receiver may be offset to a certain extent in a direction perpendicular to the optical axis (i.e., the light receiver is translated a distance relative the optical axis). Therefore, parallel movement properties may be affected.

It should be noted that the introduction to the technical background is only provided to more clearly and comprehensively describe the technical solution of the invention and facilitate the understanding of people skilled in the art. The above technical solutions shall not be considered as well-known to people skilled in the art simply because the technical solutions are described in the section of Description of Related Art of the invention.

### SUMMARY OF THE INVENTION

The embodiments of the invention provides a bijection photoelectric sensor and a target detection system capable of providing a light spot with a sufficient amount of light and in a desired shape, overcoming a W/B shadow, satisfying a smaller mounting pitch (i.e., satisfying parallel movement properties) between the bijection photoelectric sensors, and ensuring that an optical axis is easily adjustable.

According to a first aspect of the embodiments of the invention, a bijection photoelectric sensor is provided. The bijection photoelectric sensor includes a projector and a light receiver. In addition, the light projector includes the following: a light emitting device, emitting light; a first lens, converting the light emitted by the light emitting device into parallel light; and a first baffle, located between the light emitting device and the first lens, wherein a first through hole is provided on the first baffle, a center of the first through hole is overlapped with a focal point of the first lens, and a visual field formed by the light emitted by the light emitting device is controlled through the first through hole.

According to a second aspect of the embodiments of the invention, the bijection photoelectric sensor according to the first aspect is provided. In addition, the light receiver includes the following: a second lens, converging the parallel light that is incident; and a light receiving device, receiving the light converged by the second lens.

According to a third aspect of the embodiments of the invention, the bijection photoelectric sensor according to the second aspect is provided. In addition, the light receiver further includes the following: a second baffle, located between the second lens and the light receiving device, wherein a second through hole is provided on the second baffle, and a center of the second through hole is overlapped with a focal point of the second lens.

According to a fourth aspect of the embodiments of the invention, the bijection photoelectric sensor according to the first aspect is provided. In addition, a shape of the first through hole is determined by a visual field required to be formed by the light emitted by the light emitting device.

According to a fifth aspect of the embodiments of the invention, the bijection photoelectric sensor according to the fourth aspect is provided. In addition, the shape of the first through hole is a shape formed by cutting a circle.

According to a sixth aspect of the embodiments of the invention, the bijection photoelectric sensor according to the fifth aspect is provided. In addition, a diameter of the circle satisfies a relation as follows:

$$y = \frac{Y}{L} \cdot f ,$$

wherein y represents a diameter of the circle, Y represents a distance of parallel movement where the light receiver moves in parallel to a direction perpendicular to an optical axis of the first lens and the second lens, L represents a distance between the light projector and the light receiver, and f represents a focal distance of the first lens.

According to a seventh aspect of the embodiments of the invention, the bijection photoelectric sensor according to the sixth aspect is provided. In addition, the distance of parallel movement is less than or equal to 80 millimeters.

According to an eignth aspect of the embodiments of the invention, a target detection system is provided. The target detection system includes a plurality of the bijection photoelectric sensors as claimed in any one of the first to seventh aspects.

According to a ninth aspect of the embodiments of the invention, the target detection system according to the eighth aspect is provided. In addition, a distance between each two of the bijection photoelectric sensors is less than or equal to 80 millimeters.

The bijection photoelectric sensor according to the embodiments of the invention is able to provide a light spot with a sufficient amount of light and in a desired shape, overcome a W/B shadow, satisfy a smaller mounting pitch (i.e., satisfying parallel movement properties) between the bijection photoelectric sensors, and ensure that an optical axis is easily adjustable.

Specific embodiments of the invention are disclosed in detail with reference to the following descriptions and the accompanying drawings. The descriptions clearly describe examples in which the principle of the invention is applicable. However, it should be understood that the scope of the embodiments of the invention shall not be limited thereto. The embodiments of the invention may cover various modifications, changes, and equivalents without departing from the spirit and terms of the annexed claims.

The description(s) for an embodiment and/or a disclosed feature(s) may be applied in one or more embodiments in an identical or similar way, combined with a feature in another embodiment, or replace a feature in another embodiment.

It should be noted that, throughout the text, terms such as “comprise/include” refer to the presence of a feature, an assembly, a step, or a component, but do not exclude the presence or addition of another feature, another assembly, another step or another component.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view illustrating an optical path at a light projector side when a focal point of a lens is set at an LED chip in the conventional art.

FIG. 2 is a schematic view illustrating a light spot formed when the focal point of the lens is set at the LED chip in the conventional art.

FIG. 3 is a schematic view illustrating the optical path at the light projector side when the lens is arranged in a defocus state in the conventional art.

FIG. 4 is a schematic view illustrating a light spot formed when the lens is arranged in the defocus state in the conventional art.

FIG. 5 is a schematic view illustrating a structure of a bijection photoelectric sensor according to Embodiment 1 of the invention.

FIG. 6 is a schematic view illustrating an optical path at a light projector side according to Embodiment 1 of the invention.

FIGS. 7a and 7b are schematic views illustrating shapes of a through hole according to Embodiment 1 of the invention.

FIG. 8 is a schematic view illustrating an optical path when a first via 5131 is in a D-cut shape.

FIG. 9 is a schematic view illustrating a housing of a light projector or a light receiver according to Embodiment 1 of the invention.

FIG. 10 is an exploded view illustrating the light projector or the light receiver according to Embodiment 1 of the invention.

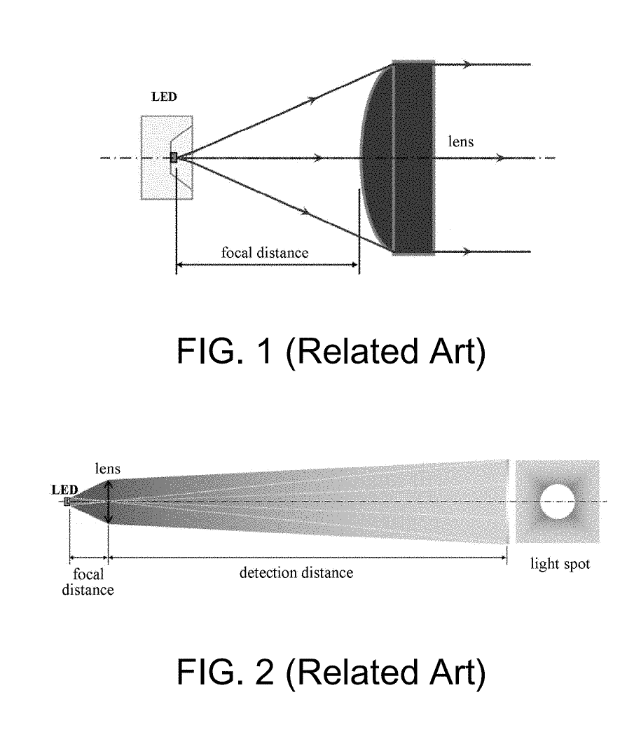

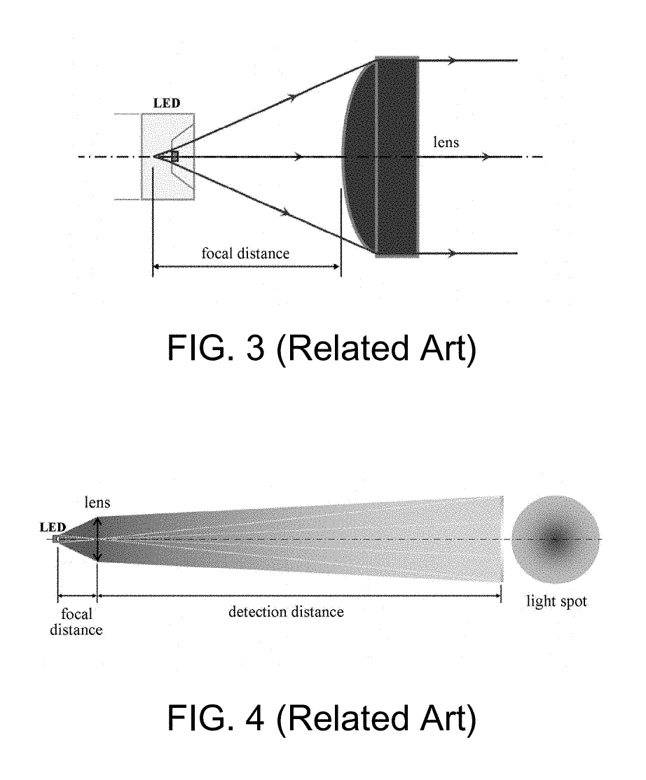

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

### Embodiment 1

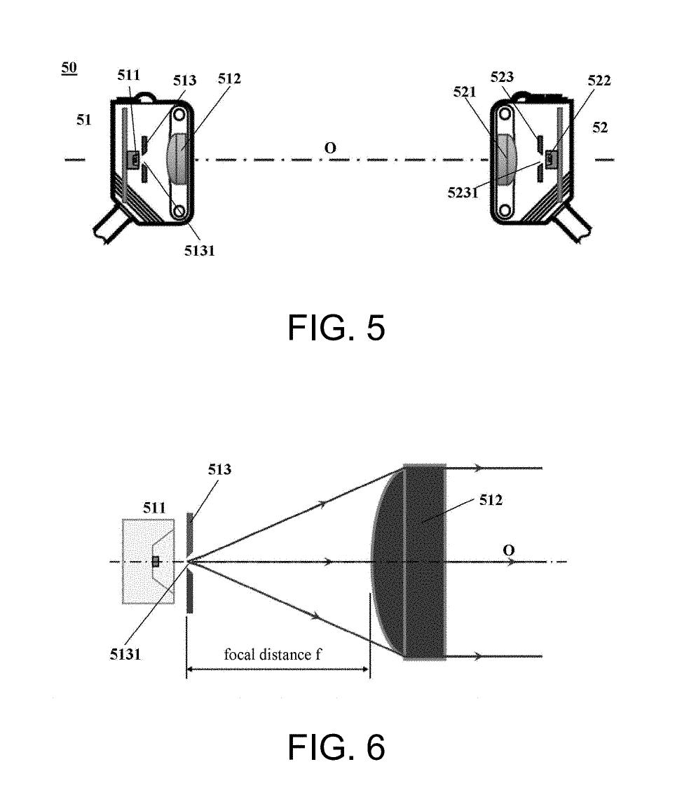

Embodiment 1 of the invention provides a bijection photoelectric sensor. FIG. 5 is a schematic view illustrating a structure of a bijection photoelectric sensor according to Embodiment 1 of the invention. As shown in FIG. 5, a bijection photoelectric sensor 50 includes a light projector 51 and a light receiver 52. FIG. 6 is a schematic view illustrating an optical path at a light projector side.

As shown in FIGS. 5 and 6, the light projector 51 may include a light emitting device 511, a first lens 512, and a first baffle 513.

The light emitting device 511 emits light. The first lens 512 converts the light emitted by the light emitting device 511 into parallel light. The first baffle 513 is located between the light emitting device 511 and the first lens 512. A first through hole 5131 is provided on the first baffle 513. The center of the first through hole 5131 is overlapped with a focal point of the first lens 512. A visual field formed by the light emitted by the light emitting device 511 is controlled through the first through hole 5131.

Since the focal point of the first lens 512 is set at the first through hole 5131, a slit illumination optical system is formed. Besides, since the first through hole 5131 (object side) and a light spot (image side) satisfy an optical object-image relation, a desired light spot size is able to be obtained by designing a shape and a size of the first through hole 5131. Hence, the requirement on parallel movement property is able to be satisfied by the design.

In the embodiment, the light emitting device 511 may be a light emitting diode (LED), for example.

In the embodiment, the light receiver 52 may be configured in a similar way as that of the light projector 51. As shown in FIG. 5, the light receiver 52 may include a second lens 521 and a light receiving device 522. The second lens 521 converges the parallel light emitted from the light projector 51, and the light receiving device 522 receives the light converged by the second lens 521. By setting a focal point of the second lens 521 at the light receiving device 522, a light spot in a desired shape may be obtained. Under the circumstance, radii of curvature of the second lens 521 and the first lens 512 are different.

In another embodiment, for the ease of processing, the light projector 51 and the light receiver 52 may have the same housing structure. In other words, a baffle (referred to as a second baffle) having a through hole (referred to as a second through hole) is also disposed in the light receiver 52, and the second baffle 523 is disposed between the second lens 521 and the light receiving device 522. Moreover, the center of the second through hole 5231 is overlapped with a focal point of the second lens 521. Accordingly, the light spot in the desired shape may also be obtained.

In the embodiment, when the focal point of the second lens 521 is located at the center of the second through hole 5231, the radii of curvature of the second lens 521 and the first lens 512 are the same, and focal distances of the second lens 521 and the first lens 512 are consequently the same. With such structure, the housing structures of the light projector 51 and the light receiver 52 are the same, and it is unnecessary to distinguish between different structures of the housings of the light projector 51 and the light receiver 52. Therefore, processing and molding become easier.

In the embodiment, the shapes of the first through hole 5131 and the second through hole 5231 are determined by a visual field required to be formed by the light emitted by the light emitting device 511 of the light projector 51. For the ease of description, the first through hole 5131 and the second through hole 5231 are generally referred to as through holes.

Normally, the light spot formed by the light emitted by the light emitting device of the light projector is in a circular shape. The circular light spot is the light projecting visual field of the light projector. In a special case, such as a subway baffle gate, since a plurality of bijection photoelectric sensors are disposed in parallel in the baffle gate, a spacing distance between the bijection photoelectric sensors is very small (e.g., less than or equal to 100 millimeters). Therefore, interferences between the adjacent photoelectric sensors need to be avoided to facilitate the accuracy of detection. Under the circumstance, the circular light spot is deformed into other shapes to narrow the light projecting visual field of the projector to prevent the adjacent photoelectric sensors from interfering with each other.

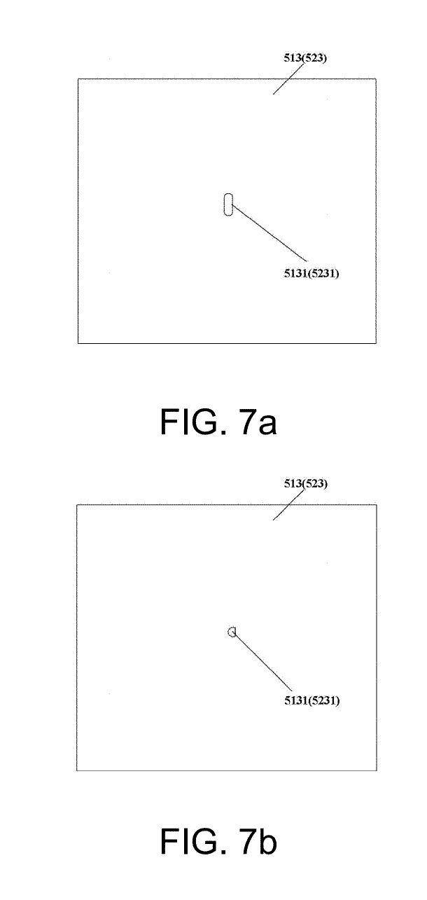

In the embodiment, for the purpose such as preventing interferences with each other, the light projecting visual field of the light projector 51 is intended to be modified. When the light projector 51 is rectangular, if it is required that the light projector 51 is mounted in vertical orientation, a visual field of a long side of the light projector 51 perpendicular to the horizontal direction needs to be a narrow visual field, and a visual field of a short side of the light projector 51 in the horizontal direction needs to be a wide visual field. According to the requirement on the light projecting visual field of the light projector, the through hole may be designed to be in a vertical D-cut shape, i.e., a shape formed after symmetrically cutting two arc portions from a circle, as shown in FIG. 7a. Accordingly, based on the optical object-image relation, the light spot formed at the light receiving device 522 of the light receiver 52 is in the vertical D-cut shape. Therefore, the mounting orientation of the light receiver is satisfied. Accordingly, a range of the light projecting visual field may be controlled by the shape of the through hole thereby ensuring that the adjacent bijection photoelectric sensors are not interfered by each other.

In addition, in the embodiment, the shape of the through hole is not limited to the D-cut shape. For example, the shape of the through hole may also be a shape formed by cutting an arc portion from a circle, as shown in FIG. 7b. With the structure, the interferences of the adjacent bijection photoelectric sensors from one side are able to be eliminated.

In the embodiment, within a range of mounting tolerance, the light receiver 52 are able to receive the light emitted by the corresponding light projector 51. Therefore, under the circumstance, a distance that the light receiver 52 is able to move in parallel to a direction perpendicular to an optical axis O of the first lens 512 and the second lens 521 is referred to as a distance of parallel movement, and a length of the distance of parallel movement determines the size of the first through hole 5131.

In the embodiment, regardless of whether the through hole is in the shape of a circle or is in the D-cut shape formed by cutting a circle, a diameter of the circle satisfies a relation as follows:

$$y = \frac{Y}{L} \cdot f ,$$

wherein y represents the diameter of the circle, Y represents the distance of parallel movement of the light receiver 52 in the direction perpendicular to the optical axis O, L represents a distance between the light projector 51 and the light receiver 52, and f represents the focal distance of the first lens 512.

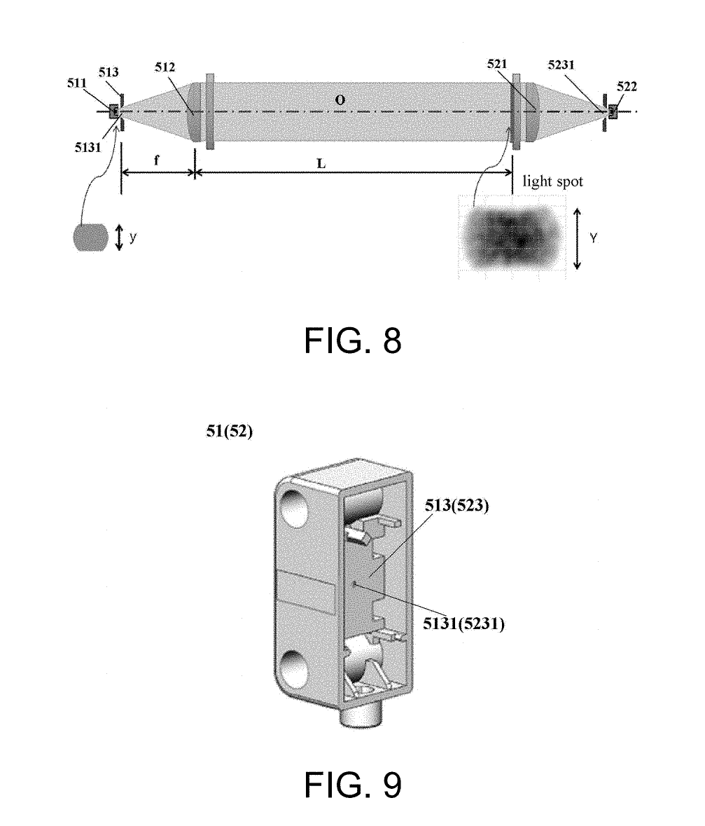

FIG. 8 is a schematic view illustrating an optical path when the first via 5131 is in the D-cut shape. As shown in FIG. 8, if it is required that the distance of parallel movement of the light receiver 52 is 60 millimeters, i.e., the light receiver 52 is allowed to move in parallel 30 millimeters above the optical axis O and 30 millimeters below the optical axis O, the light receiver 52 is generally able to receive the light emitted by the corresponding light projector 51 within the distance of parallel movement. Then, based on the distance between the light projector 51 and the light receiver 52 and the focal distance of the first lens 512, the size of the first through hole 5131 is able to be derived.

For example, assuming that the distance L between the light projector 51 and the light receiver 52 is 1000 millimeters and the focal distance f of the first lens 512 is 4.2 millimeters, the diameter y of the circular first through hole 5131 is 0.25 millimeters. Under the circumstance, the first through hole 5131 is in a shape formed by cutting a circular hole having a diameter of 0.25 millimeters on the first baffle 513.

In an embodiment of the invention, the distance of parallel movement of the light receiver 52 may be less than or equal to 80 millimeters. Accordingly, the interference requirement between the light receivers of each two bijection photoelectric sensors is met when the bijection photoelectric sensors are mounted in the subway baffle gate.

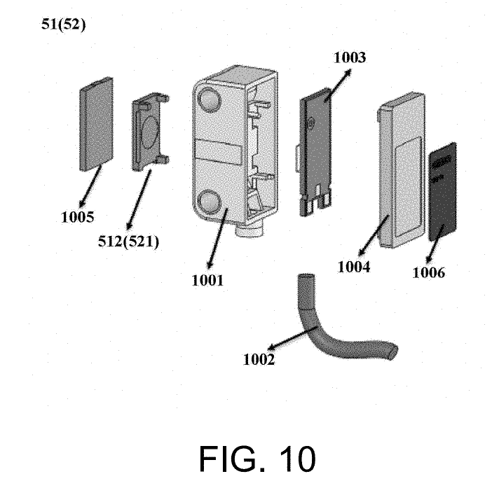

In the embodiment, the shapes of the housings of the light projector 51 and the light receiver 52 may be designed to be the same. FIG. 9 is a schematic view illustrating the housing, and FIG. 10 is an exploded view of the light projector 51 or the light receiver 52. As shown in FIG. 9, the through hole may also be disposed inside the housing and between the lens and the light emitting/receiving device. In other words, the baffle with the through hole may be integrally formed with the housing. As shown in FIG. 10, in addition to the above configuration, the light projector 51 or the light receiver 52 may further include a housing (baffle) 1101, a cable 1102, a printed wire board (PWB) 1003, a cover 1004, a lens cover 1005, and a plate 1006. Details of these components may be referred to the conventional techniques and shall not be reiterated in the following.

In the embodiment, by overlapping the center of the first through hole 5131 on the first baffle 513 and the focal point of the first lens 512, i.e., locating the focal point of the first lens 512 at the center of the first through hole 5131, a light spot with a sufficient amount of light and in a desired shape is able to be obtained without moving the light emitting device 511. In addition, a wire bonding (W/B) shadow is overcome, a smaller mounting pitch between the bijection photoelectric sensors is satisfied (i.e., satisfying the parallel movement properties), and the consistency of the optical axis is ensured.

### Embodiment 2

Embodiment 2 of the invention provides a target detection system. The target detection system includes a plurality of the bijection photoelectric sensors of Embodiment 1. Since descriptions about the bijection photoelectric sensor are already made in Embodiment 1, such descriptions will be incorporated herein and not be repeated in the following.

In the embodiment, the target detection system is able to detect whether a target (a person or an object) passes through by using the bijection photoelectric sensors. In an embodiment, the target detection system may be applied in a subway baffle gate.

In the embodiment, a distance between each two bijection photoelectric sensors may be less than or equal to 80 millimeters to satisfy the requirement of parallel movement properties.

In the embodiment, all of the light projectors of the bijection photoelectric sensors may be disposed at a side of the baffle gate, whereas all of the light receivers of the bijection photoelectric sensors may be disposed at the other side of the baffle gate. Accordingly, a controller may be disposed only at a side of the baffle gate. As a result, a space for mounting the controller is saved while detection results are not affected.

In the embodiment, with the target detection system adopting the bijection photoelectric sensors, a light spot with a sufficient amount of light and in a desired shape is able to be obtained without moving the light emitting device. In addition, the W/B shadow is overcome, the smaller mounting pitch between the bijection photoelectric sensors is satisfied (i.e., satisfying the parallel movement properties), and the consistency of the optical axis is ensured.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A bijection photoelectric sensor, comprising a light projector and a light receiver, wherein the light projector comprises:
a light emitting device, emitting light;
a first lens, converting the light emitted by the light emitting device into parallel light; and
a first baffle, located between the light emitting device and the first lens, wherein a first through hole is provided on the first baffle, a center of the first through hole is overlapped with a focal point of the first lens, and a visual field formed by the light emitted by the light emitting device is controlled through the first through hole.

2. The bijection photoelectric sensor as claimed in claim 1, wherein the light receiver comprises:
a second lens, converging the parallel light that is incident; and
a light receiving device, receiving the light converged by the second lens.

3. The bijection photoelectric sensor as claimed in claim 2, wherein the light receiver further comprises:
a second baffle, located between the second lens and the light receiving device, wherein a second through hole is provided on the second baffle, and a center of the second through hole is overlapped with a focal point of the second lens.

4. The bijection photoelectric sensor as claimed in claim 1, wherein:
a shape of the first through hole is determined by a visual field required to be formed by the light emitted by the light emitting device.

5. The bijection photoelectric sensor as claimed in claim 4, wherein:
the shape of the first through hole is a shape formed by cutting a circle.

6. The bijection photoelectric sensor as claimed in claim 5, wherein:
a diameter of the circle satisfies a relation as follows:
$$y = \frac{Y}{L} \cdot f ,$$
wherein y represents a diameter of the circle, Y represents a distance of parallel movement where the light receiver moves in parallel to a direction perpendicular to an optical axis of the first lens and the second lens, L represents a distance between the light projector and the light receiver, and f represents a focal distance of the first lens.

7. The bijection photoelectric sensor as claimed in claim 6, wherein the distance of parallel movement is less than or equal to 80 millimeters.

8. A target detection system, comprising a plurality of the bijection photoelectric sensors as claimed in claim 1.

9. A target detection system, comprising a plurality of the bijection photoelectric sensors as claimed in claim 2.

10. A target detection system, comprising a plurality of the bijection photoelectric sensors as claimed in claim 3.

11. A target detection system, comprising a plurality of the bijection photoelectric sensors as claimed in claim 4.

12. A target detection system, comprising a plurality of the bijection photoelectric sensors as claimed in claim 5.

13. A target detection system, comprising a plurality of the bijection photoelectric sensors as claimed in claim 6.

14. A target detection system, comprising a plurality of the bijection photoelectric sensors as claimed in claim 7.

15. The target detection system as claimed in claim 8, wherein a distance between each two of the bijection photoelectric sensors is less than or equal to 80 millimeters.

16. The target detection system as claimed in claim 9, wherein a distance between each two of the bijection photoelectric sensors is less than or equal to 80 millimeters.

17. The target detection system as claimed in claim 10, wherein a distance between each two of the bijection photoelectric sensors is less than or equal to 80 millimeters.

18. The target detection system as claimed in claim 11, wherein a distance between each two of the bijection photoelectric sensors is less than or equal to 80 millimeters.

19. The target detection system as claimed in claim 12, wherein a distance between each two of the bijection photoelectric sensors is less than or equal to 80 millimeters.

20. The target detection system as claimed in claim 13, wherein a distance between each two of the bijection photoelectric sensors is less than or equal to 80 millimeters.

21. The target detection system as claimed in claim 14, wherein a distance between each two of the bijection photoelectric sensors is less than or equal to 80 millimeters.
